(19) United States
(12) Patent Application Publication
(10) Pub. No.: US 2009/0044101 A1
(43) Pub. Date: Feb. 12, 2009

(54) AUTOMATED SYSTEM AND METHOD FOR CREATING MINIMAL MARKUP LANGUAGE SCHEMAS FOR A FRAMEWORK OF MARKUP LANGUAGE SCHEMAS

(75) Inventor: Winchel Todd VINCENT, III, Lexington, KY (US)

Correspondence Address: GARDNER GROFF GREENWALD & VILLANUEVA. PC, 2018 POWERS FERRY ROAD, SUITE 800, ATLANTA, GA, 30339, US

(73) Assignee: WTVIII, INC., Atlanta, GA (US)

(21) Appl. No.: 12/187,998

(22) Filed: Aug. 7, 2008

Related U.S. Application Data
(60) Provisional application No. 60/954,427, filed on Aug. 7, 2007.

(51) Int. Cl. G06F 17/00; G06F 9/44

(52) U.S. Cl. 715/234; 717/120

(57) ABSTRACT

A system for creating and realizing efficiencies in markup language (e.g., XML) schema, markup language instances, and code-generated code. A schema generator receives a markup language schema as input and automatically generates a minimal markup language schema. The minimal markup language schema, and instances conforming to it, are forwards and backwards compatible with the original markup language schema and instances. A code generator receives a markup language schema as input and generates code that can both generate and consume instances conforming to the original markup language schema or the minimal markup language schema. Accordingly, smaller markup language schemas and instances result in increased processing speed, faster transmission time, and reduced archival storage space.

### CROSS REFERENCE TO RELATED APPLICATIONS

The present application claims the benefit of priority to U.S. Provisional Patent Application Ser. No. 60/954,427 filed on Aug. 7, 2007, which is incorporated herein by reference in its entirety for all purposes.

### FIELD OF THE INVENTION

The present invention relates generally to markup language schemas, and more particularly, to a system and method for generating minimal markup language schemas and code.

### BACKGROUND OF THE INVENTION

Extensible Markup Language (XML) is a specification developed by the World Wide Web Consortium (“W3C”). XML has become an increasingly more important markup language used in the exchange of data and documents (“XML documents” or “XML instances”) on the World Wide Web and elsewhere. XML allows designers to create their own data and document formats (“formats”). XML formats are customized tags (i.e., elements and attributes), enabling the definition, transmission, validation, and interpretation of data between applications and between organizations. Schemas define markup language formats. The W3C, OASIS, and other organizations have published specifications for creating schemas (e.g., the W3C's XML DTDs and XML Schema, and OASIS' Relax NG).

Prior to the W3C publication of XML in the late 1990s, two related technologies existed: Structured Generalized Markup Language (“SGML”) and Hypertext Markup Language (“HTML”). SGML is a technology like XML. According to the W3C in the late 1990s, the problem with SGML, and the reason it had not gained wide-spread acceptance, was that it was too complex. Indeed, in the late 1990s, the W3C advertised XML as a simplified version of SGML. Like XML, SGML allows a schema designer to create a markup language format of customized tags.

Although related, HTML is not the same as SGML or XML. Rather, HTML is a markup language format defined by an SGML Document Type Definition (“DTD”). As a markup language format, and an international standard, HTML is a pre-defined, finite set of tags (i.e., elements and attributes). In the late 1990s, HTML had gained wide-spread international acceptance as the language of the world wide web, even though other SGML formats and SGML itself had not gained such wide-spread acceptance. While HTML is and has been extraordinarily useful in the early development of the World Wide Web, it has relatively limited use in the context of a much larger world of electronic data and document exchanges.

Since 1990, XML has opened a new era for markup language formats and tagged data. On one hand, XML is relatively easy to use to create new, custom markup language formats. On the other hand, tagging data is not limited to the finite set of HTML tags. The ability for anyone to create any markup language format with relative ease is both advantageous and disadvantageous in the world of electronic data and document exchanges. XML's flexibility results in a Tower of Babel effect where many languages (e.g., formats) exist, but not everyone (humans and machines) can easily understand all formats.

A generally accepted, industry-wide practice intended to mitigate XML's Tower of Babel effect is to define fully-spelled (or relatively long, if not always fully spelled), human readable names when designing a schema. For example, naming an element “FirstName” or “LastName” instead of “f” or “n” is helpful to a third-party's understanding of a schema, and instances conforming to it, since “f” could just as easily represent “Football” as it could “FirstName.” While this practice is advantageous to human-understanding, it disadvantageously results in verbosity that increases a variety of performance costs (e.g., verbosity decreases technical performance, increases electronic transmission times, and increases physical space necessary to store volumes of markup language instances).

Some performance problems can be ameliorated using existing techniques known to those skilled in the art. Such techniques include, for example, hardware acceleration and data compression. These technologies, however, have their limitations. Hardware accelerators tend to be expensive and are impractical to install on mobile devices and personal computers. Hardware accelerators are most practical in centralized data centers with large-scale server environments, but even in these environments performance is an issue and is ever in need of optimization. Hardware accelerators do not help with transmission times or storage space. Data compression techniques can help with transmission times and storage space, but incur processing overhead because instances must be compressed and decompressed.

Therefore, there exists in the industry a need for a system and method that provides markup language schemas that are human readable in certain environments but can be easily and precisely used in mechanical environments to achieve optimal run-time performance.

### SUMMARY OF THE INVENTION

The present invention provides developers an automated system and method for creating and realizing efficiencies in markup language (e.g., XML) schema and code-generated code. Advantageously, the present invention provides smaller instance documents resulting in smaller document repositories (i.e., reduced archive space for volumes of instance documents) and faster transmission time; smaller markup language schemas for faster process time, including instance validation; and smaller but more efficient and faster code-generated code.

These and other features and advantages of the present invention will become apparent from the following description, drawings and claims.

### BRIEF DESCRIPTION OF THE DRAWINGS

FIG. 1 is a block diagram representation of a system for developing and managing markup language schemas and documents in accordance with an example embodiment of the present invention.

FIG. 2 is a block diagram representation of a schema framework of FIG. 1.

FIG. 3 shows a primary markup language schema and its dependant sub-schemas, before and after namespace transformation according to an example embodiment of the present invention.

FIG. 4 depicts a flow diagram of a method of processing elements to create a minimal markup language schema according to an example embodiment of the present invention.

FIG. 5 depicts a flow diagram of a method for minimizing a set of item names according to an example embodiment of the present invention.

FIGS. 6-10 depict an implementation of the method of FIG. 5 as applied to an example list of elements.

FIG. 11 is a pictorial representation of how a compound element is minimized according to the method of FIG. 5.

FIG. 12 depicts a representation of a list of namespace prefixes of markup language schemas related to a primary markup language schema as processed per the method of FIG. 5.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

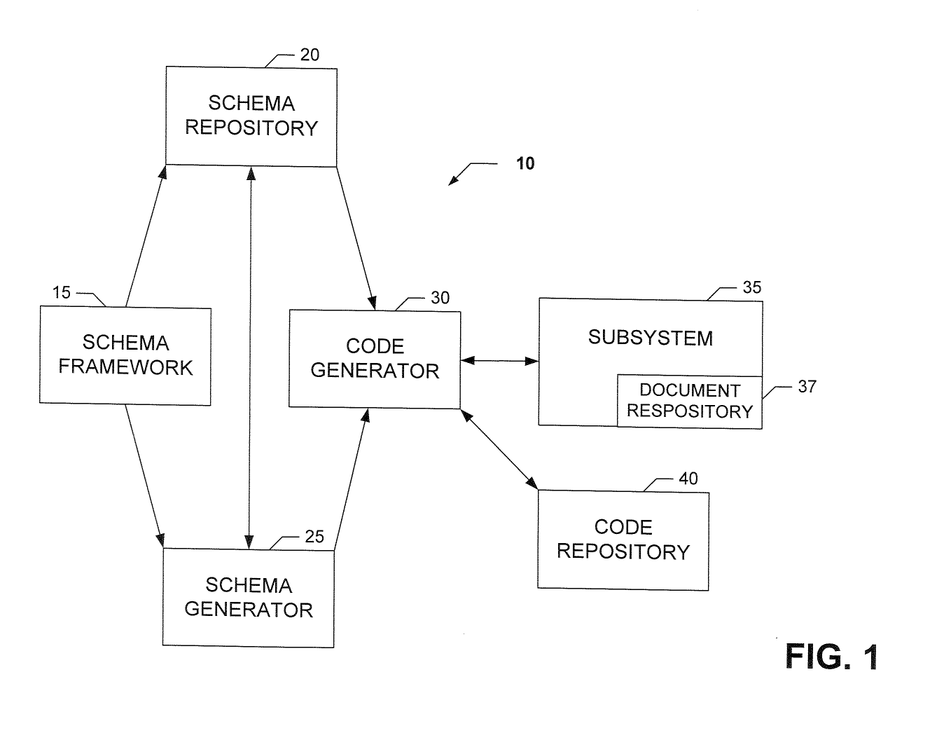

FIG. 1 depicts a block diagram of a system 10 for developing and managing markup language schema and using the markup language schema to author and manage content in accordance with an example embodiment of the present invention. Preferably, the system 10 comprises a schema framework 15 that describes rules that govern the operation of a schema repository 20, a schema generator 25, and a code generator 30. The schema repository 20 and the schema generator 25 communicate between each other and with the code generator 30. The code generator 30, in turn, communicates with a content authoring, management, and electronic filing subsystem 35, including a document repository 37, and a code repository 40. It should be noted that the system 10 operates on one or more computers (or network of computers) and includes one or more data storage systems which store or otherwise record schema, code, and instance documents on one or more computer-readable media. Data storage systems and repositories can include devices of any suitable medium, such as random-access memory, read-only memory, FLASH memory, magnetic or optical disk storage, etc., or any suitable combination thereof.

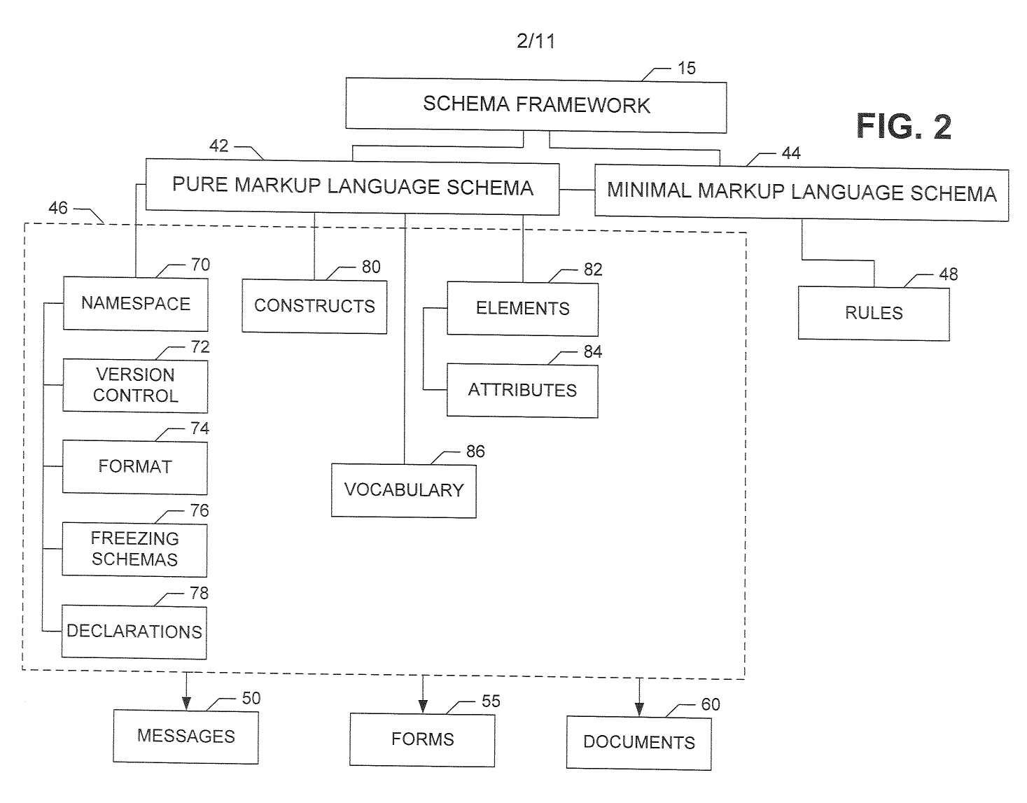

As shown in FIG. 2, the present invention provides a system and method, including one or more rules 48, for transforming a “pure markup language schema” 42 (also called an “original schema”) into a “minimal markup language schema” 44 within the schema framework 15. As used herein, a “pure markup language schema” refers to a schema framework schema that has been created with long element, attribute, complex types, simple type, and group names. A “minimal markup language schema” is a schema framework schema with the same structure as the original pure schema, but with preferably the smallest (or near smallest) possible element, attribute, complex types, simple type, and group names. A pure markup language schema and a minimal markup language schema are logically and semantically the same, but for the length of the names in the markup language schemas. Stated another way, pure markup language schema and instances are preferable for human consumption, whereas minimal markup language schema and instances are preferable for machine consumption. Also, as used herein, the schema framework 15 provides a set of rules 46, or best practices, for developing pure markup language schemas 42 that can be used to create messages 50, forms 55, and documents 60, as described in the example embodiment of FIG. 2 and further described in U.S. Pat. No. 7,366,729 filed on Jun. 10, 2004 and titled “SCHEMA FRAMEWORK AND A METHOD AND APPARATUS FOR NORMALIZING SCHEMA” and in U.S. Pat. No. 7,308,458 filed on Jun. 10, 2004 and titled “SYSTEM FOR NORMALIZING AND ARCHIVING SCHEMAS,” which are incorporated herein by reference in their entireties for all purposes. For example, the schema framework 15 can define rules 46 of construction for the schema namespace 70, including version control 72, format 74, freezing the schema 76, and namespace declarations 78. Additionally, the rules 46 can include rules governing constructs 80, elements 82, attributes 84, and vocabulary 86. In alternative embodiments, the schema framework can define additional, fewer, and/or other rules of construction.

Preferably, the markup language schemas 42 of the present invention use the W3C XML Schema 1.0 as a basis for creating the schema framework. However, other types of structured markup language or versions of schemas could be used, such as Structured Generalize Markup Language (SGML) schemas, XML Document Type Definitions (DTDs), a future version of W3C XML Schema, or OASIS' RELAX NG Schema.

### Namespace Generation

Preferably, the markup language namespace of the minimal markup language schema 44 is generated from the primary schema of the pure markup language schema. As generally well known to those skilled in the art, a markup language namespace is defined as a collection of names, identified by an IRI reference, which is often an URI reference, that are used in markup language documents to distinguish or qualify the context of elements, and attributes, and other schema names and constructs. In an example embodiment, the namespace for the minimal markup language schema 44 is generated from the pure markup language schema's primary schema by:
(1) Adding a short string of text, such as the text xm/ as described in an example embodiment of the present invention, to the end of the pure markup language schema's primary schema's namespace (for primary schemas and dependant sub-schemas), and
(2) Then adding the first letter of primary schema (for primary schemas and dependant sub-schemas) followed by a slash (e.g., */, where * is a single letter).

Additionally, for dependant sub-schemas, the root element, such as for example “?/”, of the minimal markup language schema 44 can be one or more characters (e.g., letters or numbers). The “?” can be any alphanumeric character, and is preferably the first character of the name of the root element. Preferably, the version number of the pure schema, if any, is omitted. As defined herein, the term “sub-schemas” refer to schema framework markup language schemas in a subdirectory of the primary markup language schema, even if the primary markup language schema did not directly or indirectly import the markup language schema. Dependant sub-schemas, in contrast, are those schemas that are imported directly or indirectly by the primary schema, regardless of their position in a directory structure. In other words, dependant sub-schemas refer to all schemas in a schema set, required directly or indirectly for validation, regardless of position in the directory structure.

An example of transforming a pure markup language schema to a minimal markup language schema follows: Assume the pure markup language schema is identified as “http://www.xmllegal.org/Schema/BuildingBlocks/Address/Test02/”, then the system 10 of the present invention can transform the pure markup language schema to the minimal markup language schema:

“http://www.xmllegal.org/Schema/BuildingBlocks/Address/Test02/xm/a/”.

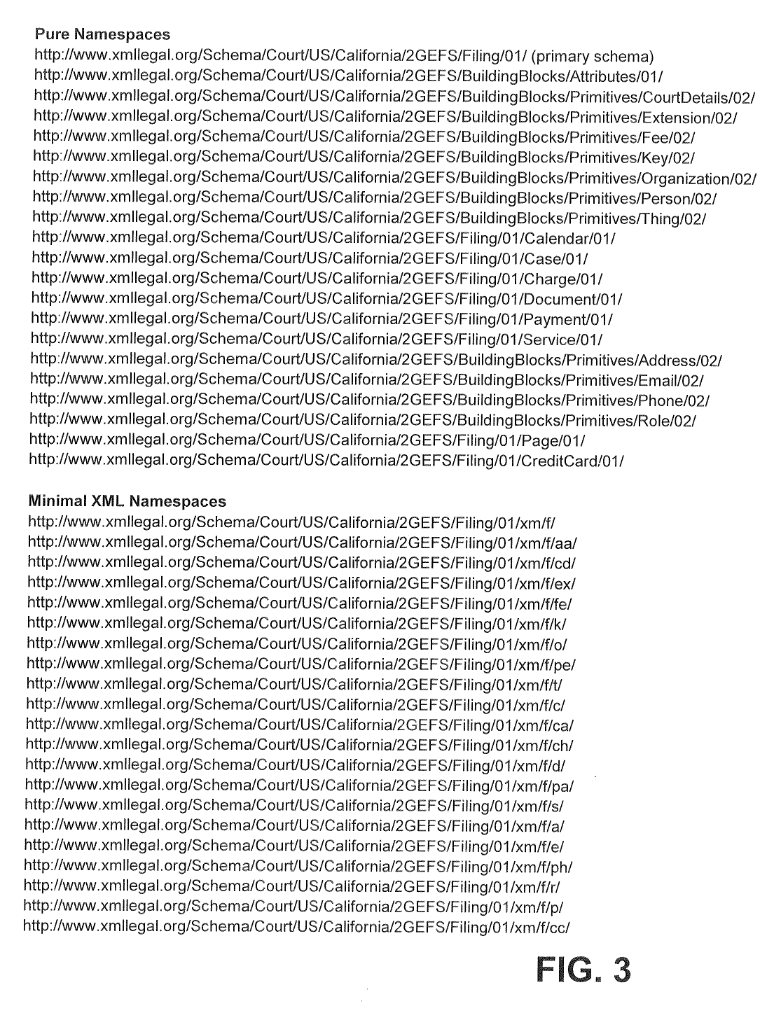

Preferably, dependant sub-schemas are transferred into subdirectories of the primary schema's xm/ directory and therefore, the xm/ suffix is preferably omitted for dependant sub-schemas. For example, FIG. 3 shows a primary schema and its dependant sub-schemas, before and after namespace transformation. Preferably, in the schema framework 15, the namespaces match or can be mapped to a directory structure in an automated way.

As can be appreciated by those skilled in the art, the namespace string is preferably reduced for at least the majority of the namespaces. In this example, the total reduction in characters from the original pure namespaces to the minimal namespaces is 1803 characters to 1562 characters, a reduction of nearly 15%.

The minimal directory name in which the sub-schemas exist can be determined by the processing rules described herein.

For example:

Primary Pure:

http://www.xmllegal.org/Schema/US/Court/Filing/01/

Primary Minimal:

http://www.xmllegal.org/Schema/US/Court/Filing/01/Envelope/01/xm/e/

Subschema Pure:

http://www.xmllegal.org/Schema/US/Court/Filing/01/Envelope/01/Calendar/01/

Subschema Minimal:

http://www.xmllegal.org/Schema/US/Court/Filing/01/Envelope/01/xm/e/c/01/

Subschema Pure:

http://www.xmllegal.org/Schema/US/Court/Filing/01/Envelope/01/Case/01/

Subschema Minimal:

http://www.xmllegal.org/Schema/US/Court/Filing/01/Envelope/01/xm/e/ca/01/

As generally well known to those skilled in the art, possessing a markup language instance document allows a processor to know the markup language schema namespace. In the schema framework 15, knowing the markup language schema namespace allows the processor to find the markup language schema. For primary markup language schemas, minimal markup language schema namespaces have an additional quality in that the processor can not only find the minimal markup language schema, but the processor can also find the pure schema. For dependant sub-schemas, knowing the minimal sub-schema namespace is not generally a reliable means of determining the pure subschema namespace, because (a) some pure schemas may be located in a different directory structure and (b) the minimal directory name (e.g. c or ca) can vary from schema-set to schema-set. To determine pure subschema namespaces, the pure primary schema can be inspected. Even so, every minimal namespace can point to the primary schema, which in turn provides information to find every other pure schema. Stated in a different way, all pure and minimal markup language schemas in a set are discoverable or derivable by knowing either the pure primary schema, any minimal markup language schema in a set, or one valid instance, whether pure or minimal. Thus, the minimal markup language schema, and instances conforming to it, are forwards and backwards compatible with the original markup language schema and instances.

Described below is a method of implementing a transformation of pure markup language schemas 42 to minimal markup language schemas 44 according to a typical commercial embodiment. Those skilled in the art will understand that the framework and “rules” provided herein are exemplary and that other and/or additional “rules” and frameworks can be used as well.

### Example Rules

In the example embodiment, the system 10 includes a rule for namespace generation for global attributes. A schema framework Attributes.xsd file (which could be a building block schema) file is moved into the xm/ directory as a subschema of the primary schema. The namespace prefix for the minimal attributes schemas is fixed to “aa”. This prefix is typically reserved and not used for any other minimal namespace prefix. The global attribute group name is shortened to “g” and is fixed. Preferably, no other attribute group may use “g” as a name. If other attribute groups exist, the group names can be determined by the additional rules as discussed herein. For example, if the global Attributes schema of a primary pure markup language Address schema is:

“http://www.xmllegal.org/Schema/Building Blocks/Attributes/03/”

then the minimal markup language global Attributes schema can be

“http://www.xmllegal.org/Schema/Building Blocks/Primitives/Address/Test02/xm/a/aa/”.

Another example is if the primary pure markup language schema is

“http://www.xmllegal.org/Schema/US/Court/Filing/01/Envelope/01/”

then the minimal markup language global Attributes schema can be

“http://www.xmllegal.org/Schema/US/Court/Filing/01/Envelope/01/xm/e/aa/”.

Also in the example embodiment described herein, a number of item names are preferably shortened and some are optionally (or may be) shortened. As used herein “item names” refers to any one or more of element, attribute, complex types, simple type, and group names.

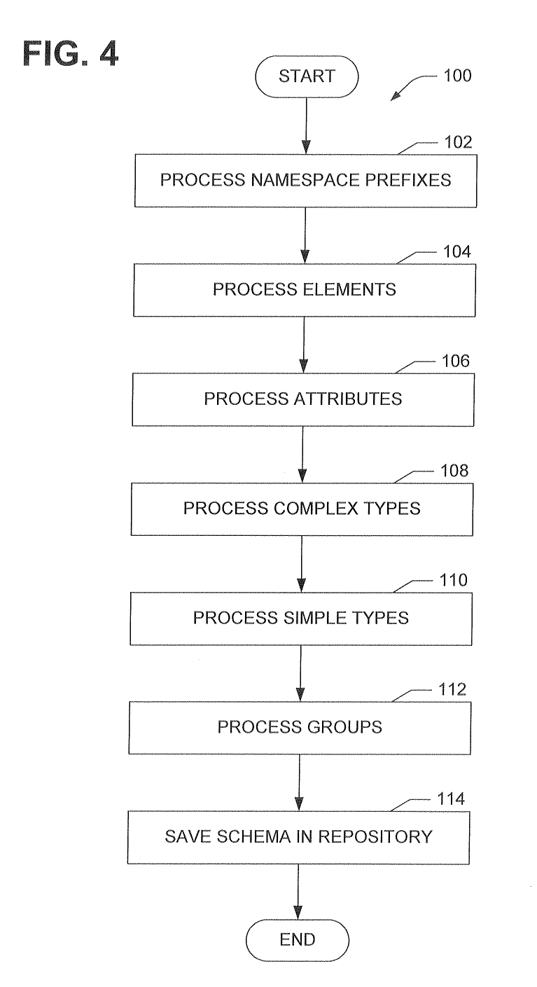

FIG. 4 depicts a flow diagram of method 100 (or an example rule of the present invention) that provides the order in which each type of name is processed according to an example embodiment of the present invention. Beginning at step 102, namespace prefixes are processed first. Proceeding to step 104, elements are processed second. At step 106, attributes are processed. Global attributes are preferably processed before local attributes. Local attributes are preferably processed in the context of the element they modify (and not with respect to the entire markup language schema). This can be done because the attributes are local attributes, not global attributes. Because conventional W3C Schema rules will not allow a conflict between a local attribute name and global attributes, global attributes are typically known and preferably reserved, and therefore when processing local attributes, local attributes will not have a duplicate name.

Proceeding to step 108, internal complex types are processed such that they match the name of the element to which the complex type is associated. External complex types match the prefix/root element of the imported schema. Optionally at step 110, simple types are processed. Because conventional W3C Schema rules will not allow simple type names and complex type names to be the same, complex type names for the schema are typically known, and therefore simple type names are not duplicated when they are processed. Another optional step is step 112, where the groups are processed. At step 114, the system 10 saves the schema in the schema repository 20 (which can be local). Preferably, prior to the step of saving the schema, the system checks whether the resulting schema is a valid W3C schema and whether it is a normalized schema framework schema (i.e., a normalized schema complies with the one or more rules of the schema framework rule set). If the schema is not a W3C schema or is not normalized, the system 10 can reprocess and/or normalize the schema, such as in a manner described in U.S. Pat. Nos. 7,366,729 and 7,308,458. Preferably, enumerated values are not processed. The method 100 ends.

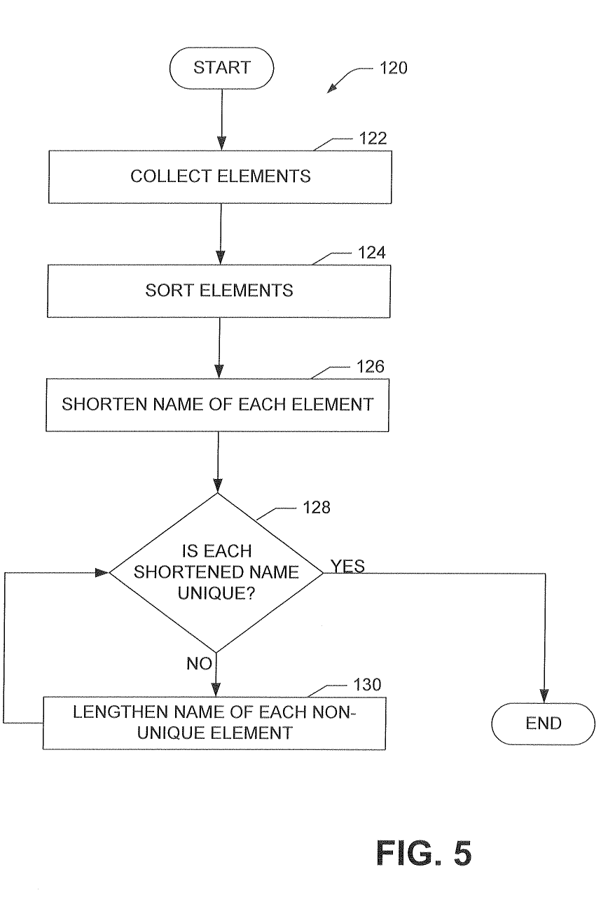

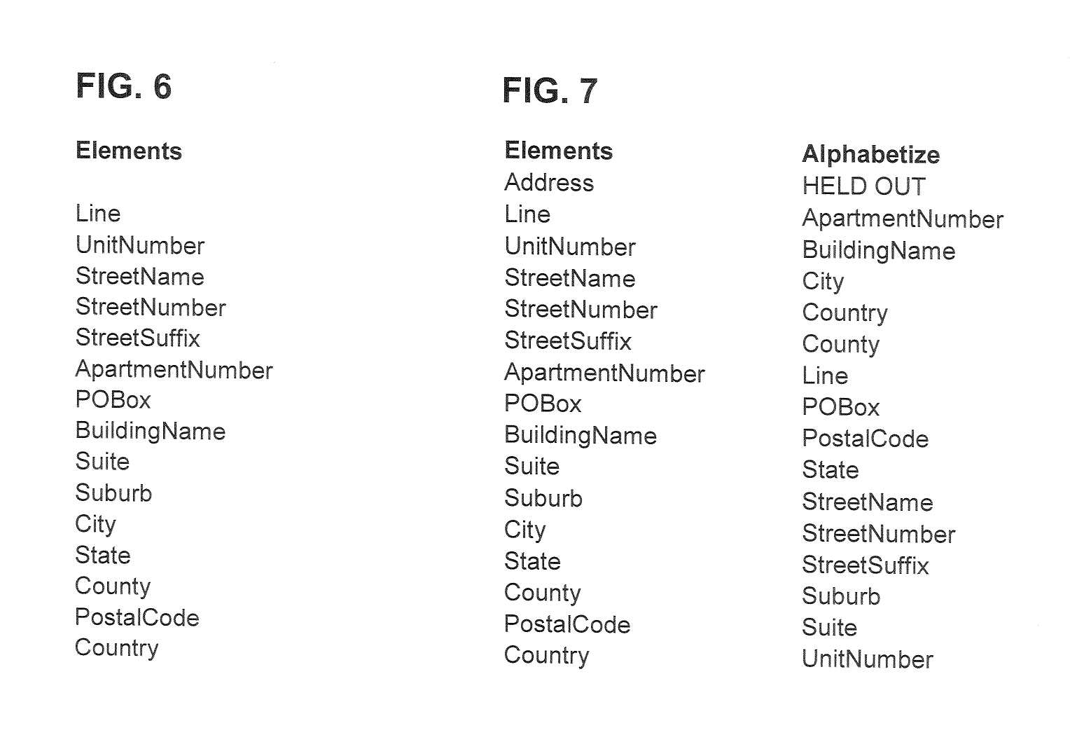

FIG. 5 depicts a flow diagram of a method 120 (or an example rule of the present invention) for minimizing a set of element names. FIGS. 6-10 depict an example implementation of this method. The method 12 begins at step 122 where a full list of elements is collected and items that are held out or reserved are marked accordingly. An example list is shown in depicted in FIG. 6.

At step 124, the list is sorted. Preferably, the list is sorted alphabetically, as shown in FIG. 7. In an alternative embodiment, the list can be sorted in another logical manner. In some cases, one or more names will be held out or reserved. In the example of FIGS. 6-7, the root element Address, which is also the namespace prefix, is held out. In this example, Address would have been the first element in the alphabetical list (because it begins with the letters “Ad”). However, even if it had not been the natural first element in the list, if there were a duplicate, it would have been minimized to a single character, because it is the root element and was held out. That is, the root element is typically held out as the first element in the list and is therefore typically a single character.

At step 126, each name is shortened to a single character, which is preferably the first character of the name. In some cases, one or more names may be held out or reserved. At step 128, the system 10 determines whether each shortened name in the list is unique within the list (i.e., the system performs a “unique test”). In other words, the system 10 is determining whether any of the shortened names are duplicates of each other. If each shortened item name (or sometimes referred to herein as “value”) in the list is unique, then the method 120 ends.

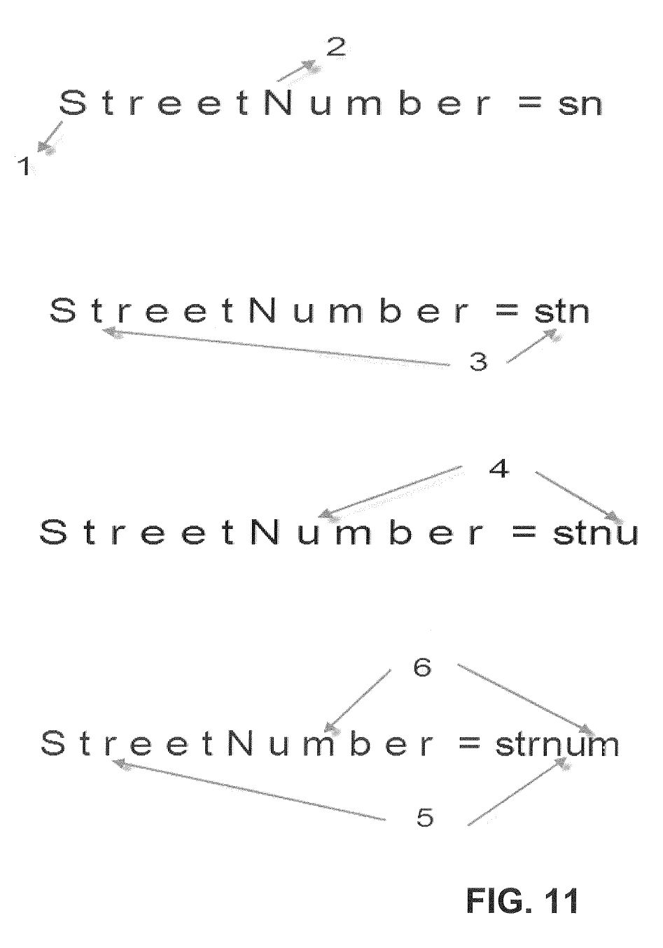

If not and if the unique test fails (i.e., if at least one shortened item is not unique), then at step 130, the system lengthens the value of each non-unique item as follows. For each value that is unique within the list, that value preferably remains the same. For two or more values that are the same, the first value in the list (e.g., the first value in the alphabetical listing) preferably remains the same. A second character is added to subsequent values as defined by the following steps, although other techniques can be used and still be within the scope of the present invention. If there is a second or subsequent capital letter in the name, then that letter is selected as the second letter. If there is not a second or subsequent capital letter, then the next letter after the first capital letter is selected. Step 128 is repeated to determine whether all names are unique. If not, the system adds a third letter. The next capital letter is selected if there is one. If not and if there are multiple capital letters, additional letters are selected after the capital letters, each in turn (see for example FIG. 11). If there is only one capital letter, then the next unused letter in the string is selected. Preferably, the minimal markup language schema names are all lowercase, although in alternative embodiments all uppercase characters or a combination of uppercase and lowercase characters can be used. The process ends when each shortened name is unique in the context of all names in the evaluated list.

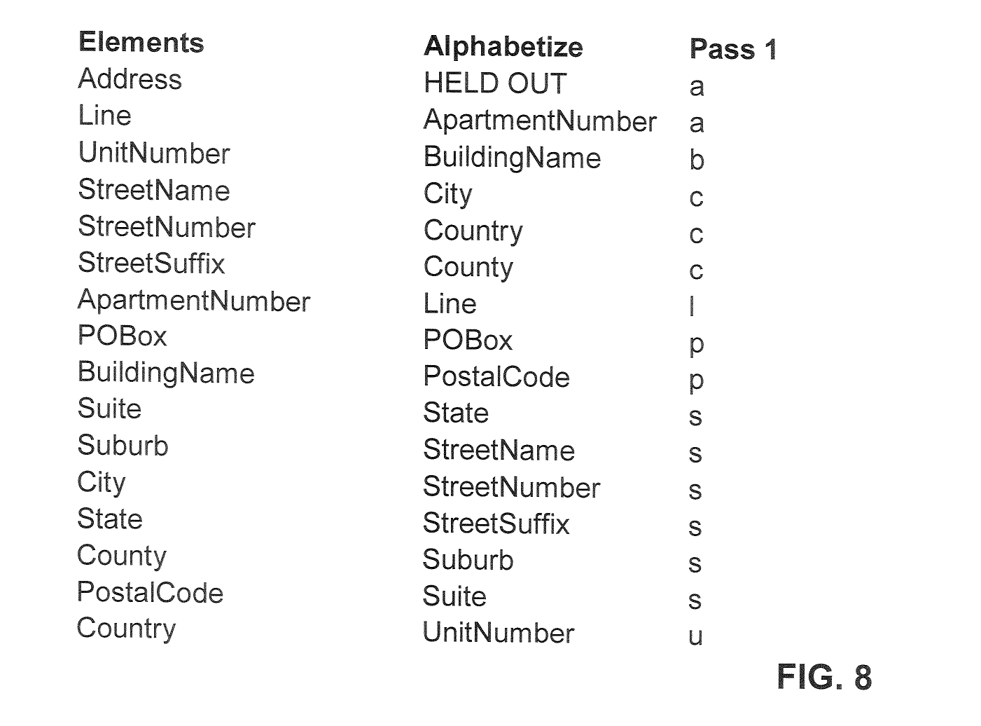

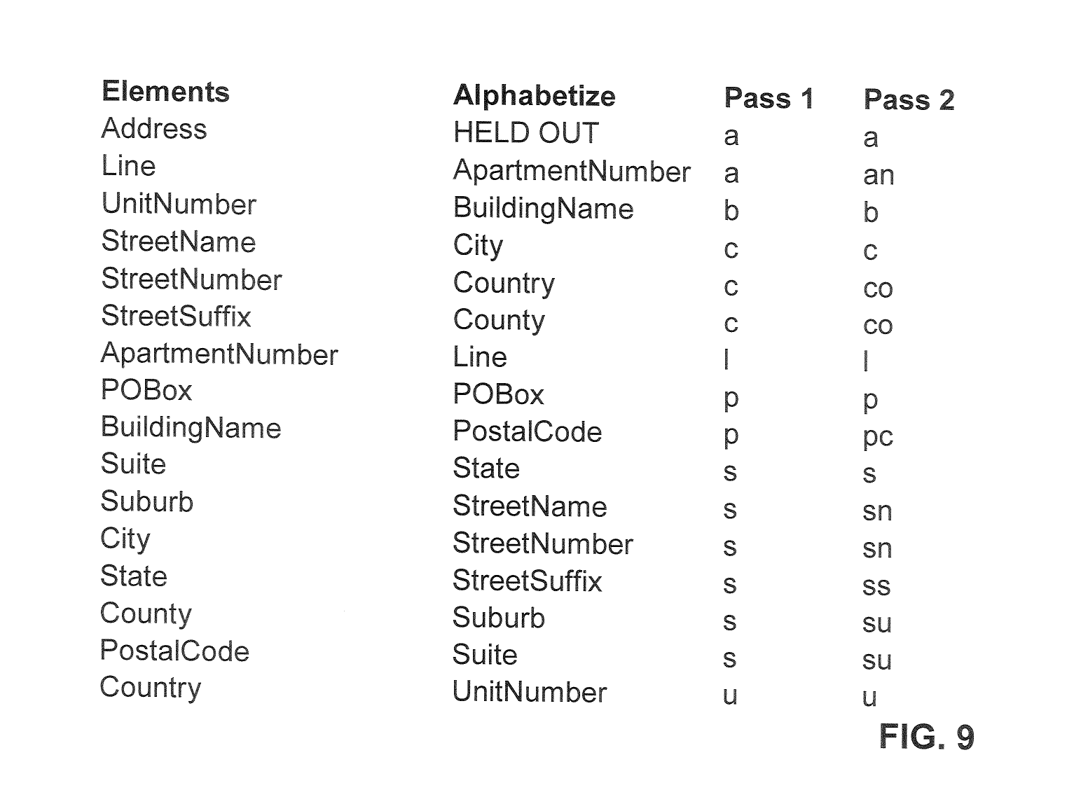

As shown in FIG. 8, there are four groups of duplicates (i.e., multiple occurrences of “a,” “c,” “p,” and “s”). Thus, this list is not completely unique. Because the list is not completely unique, the method repeats steps 128 and 130. FIG. 9 shows the first repeated steps in “pass 2.” Note, in the first group (“a” group) even though the root element is held out, it is still evaluated with other elements. In this example, ApartmentNumber results in the minimized name “an” because the letter “N” is a second capitalized letter. If the name had been Apartment, then the minimized name would have been “ap”. In the second group (“c” group) the first occurrence of “c” remains the same. The next two occurrences take the next letter after the first capital letter, since there is no other capital letter in the name. In this list, the second and third “c” values become “co”. In the third group (“p” group), the first occurrence of “p” remains the same. The next occurrence becomes “pc”, because PostalCode has two capital letters. In the fourth group (“s” group), there are six members of the group. The first occurrence of “s” remains the same. StreetName and StreetNumber both become “sn” (second capital). StreetSuffix becomes “ss” (second capital). Suburb and Suite become “su” (no capital, so take next letter). Because the list is still not unique as determined at step 128, the rule goes through another pass at step 130.

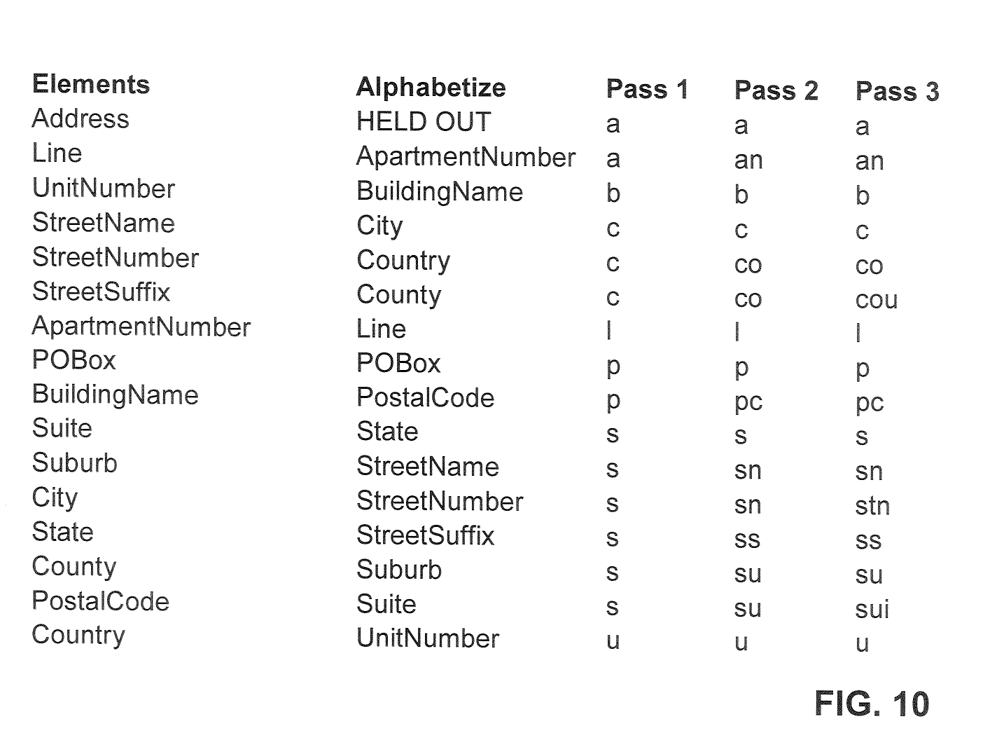

As shown in FIG. 10, in the first group (“co” group), the first occurrence (i.e., the first occurrence alphabetically) of the letters “co” remains the same. The second occurrence takes the next letter of the name and becomes “cou”. In the second group (“sn” group), the first occurrence the letters “sn” remains the same. The second occurrence takes the next letter after the first capital letter and becomes “stn”. Preferably, the letter is placed in its position after the initial capital letter.

FIG. 11 shows how a compound element takes letters in an example embodiment. Thus, StreetNumber is strnum according to an example embodiment. If all letters were selected, then eventually, the following would result:

StreetNumber=streetnumber

The same would be true for names that included three or more capital letters. For example, DateOfBirth would become “d”, “do”, “dob”, “daob”, “daofb”, “daofbi”, “datofbi”, “datofbir”, “dateofbirt”, and “dateofbirth”. Advantageously, this technique allows the potential creation of acronyms (e.g., “dob” for “DateOfBirth”) which then allows human readability of minimal schemas. However, other techniques of minimizing such item names are within the scope of the present invention.

The minimal namespace prefix of a primary markup language schema is typically the first letter of the pure schema's root element. For example, if a primary schema's root element and namespace prefix were “Filing”, then the minimal markup language schema's root element and namespace prefix is “f”. Preferably, the primary schema's minimal namespace prefix is not more than one character, although in alternative embodiments, the primary schema's minimal namespace prefix can include a plurality of characters.

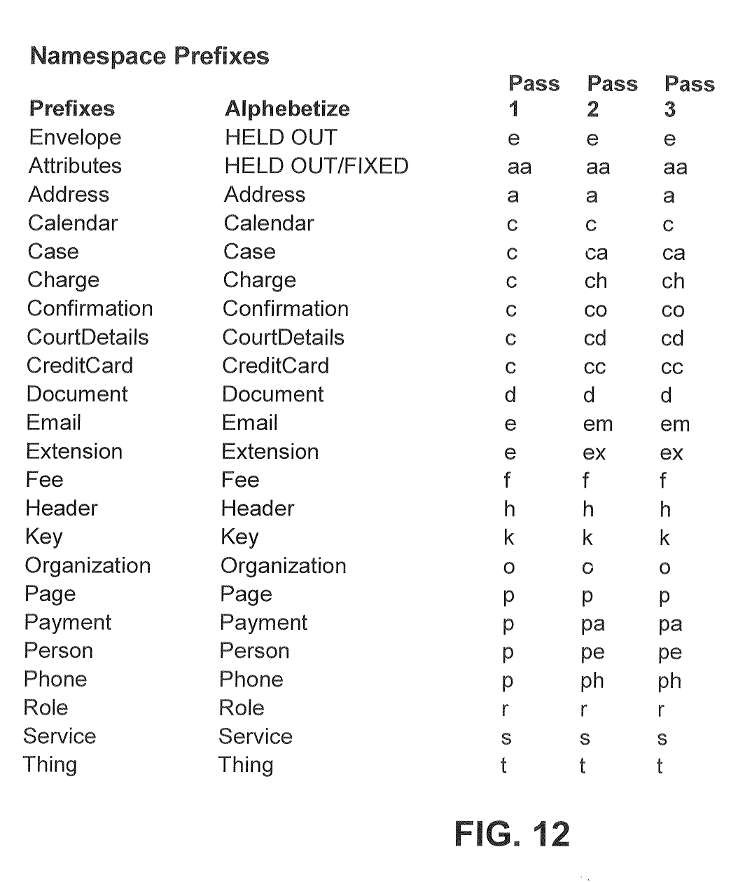

If a primary schema has one or more subschemas or related schemas (i.e., building blocks) then all namespace prefixes associated with the primary schema are preferably processed prior to processing elements for a given set of schemas, as shown in FIG. 12. This is because the prefixes can be used as the root element names of each subschema and are preferably held out of the processing of the elements for each individual schema.

Preferably, the primary schema's namespace prefix is held out, as is the Attributes namespace prefix, which is also held out and fixed as “aa”. Also preferably, the namespace prefix for “Case” will become “ca”. This means that the root element of the minimal markup language schema for “Case” will also be “ca”. The markup language schema will be ca.xsd in the ca/ directory. Since the Case schema is a subschema, its root element is held out, but it will preferably not be a single letter, as is the case with the primary schema. Preferably, the namespace prefixes (i.e., root elements) are held out for sub schemas, to avoid conflict that would arise if every subschema's root element were simply defaulted to a single letter.

Preferably, the root element of a markup language schema is always held out. If the markup language schema is a primary markup language schema, then the element name is preferably a single character. If the markup language schema is a dependant sub-schema, then the root element can be determined by the results of the minimal xml processing rules as applied to the schema set's namespace prefixes.

Preferably, global attributes in the Attributes.xsd are processed first. Each minimal global attribute name is preferably reserved, such that when local attribute names are processed, the local attribute name will not conflict with a global attribute name. Preferably, each local attribute is evaluated in the context of the element with which it is associated but not evaluated in the context of the entire markup language schema.

Preferably, internal complex types use the same name as the element to which it is associated (i.e., whatever the minimal element name as determined by the processing rules). External complex types (used by the complex type “type” attribute) match the namespace prefix (and root element) of the imported schema to which the type corresponds. For example:

Internal: Filing:Message of type Filing:Message (me of type me)

External: Filing:Person of type Person:Person (f:p of type pe:pe)

External: Filing:Judge of type Person:Person (f:ju of type pe:pe)

In the second example above in the context of the “Filing” schema, the minimal xml name for the Person element is “p”, whereas in the context of the Person schema, the minimal xml name for the Person element is “pe”. This is possible, since the Person elements are processed in different contexts (i.e., Filing and Person) and therefore can be minimized in different ways. Minimization is preferably done in the context of a schema as a primary schema, notwithstanding that the schema may be a dependant sub-schema of other primary schema.

In an example embodiment, simple type names are optional to process. Minimizing simple type names will make the schema somewhat smaller, but usually not by much, unless there are many simple types. Minimizing simple types will generally have no effect on the size of instance documents. Complex type names are known and reserved at the time of processing simple types names, because the complex type names cannot conflict with the simple type names, per W3C XML Schema rules.

In an example embodiment, element groups are processed by the general rules. There are typically no group names that are held out. Attribute group names are processed by the general rules, preferably with the letter “g” reserved for the Attributes:Global group.

Preferably, enumerated values are not processed or minimized because the enumerated values appear as data in associated XML instance documents. The intention is to minimize the length of schema structures, but not to otherwise change the marked-up data from one format to the other. Similarly, the same rule applies to default values for attributes.

The minimal xml schema generation process may optionally include the generation of an element manifest. An element manifest is a set of optional attributes with fixed values that exist on the root element of a schema and that appear on the root element of associated instance documents. An element manifest preferably includes an attribute for each original (i.e., pure) element with a default value equal to minimal element. For example, the following is a partial example of an element manifest that would appear on the root element of a minimal xml Address instance document:

a:a Address=“a” ApartmentNumber=“an” Line=“I” StreetNumber=“stnu”

Alternatively or additionally, a manifest can be created using fully spelled strings in minimal markup language schema namespaces (although in such an embodiment, longer namespaces may result and may not be optimal from a performance perspective). Those skilled in the art will notice the usefulness of a manifest in being able to interpret element names from an instance alone, without the need to fetch the pure schema from which the minimal markup language schema was derived.

### Freezing Pure and Minimal Markup Language Schemas

Pure markup language schemas are preferably frozen prior to creating a minimal markup language schema such that the pure markup language schema cannot be changed. The reason is that the processing rules applied to the pure markup language schema preferably produce the same results every time to produce the same minimal markup language schema set. When a pure markup language schema is frozen, the minimal markup language schema is likewise frozen. With both schemas frozen, code generation can occur. If the pure schemas are not frozen, then an issue of incompatibility with previously created minimal markup language schemas may arise. If both the pure schema and the minimal schemas are not frozen, then an issue of incompatibility with previously generated code may arise.

### Documentation and Dictionaries

Preferably, documentation and data dictionaries for pure markup language schemas include a mapping to minimal xml structures of associated minimal markup language schemas. Likewise, documentation for minimal markup language schemas preferably includes a mapping to pure xml structures. Thus preferably, there is a documented one-to-one mapping of all schema structures, with the exception of the element manifest, in addition to a mechanical mapping.

### Packages

Schema packages (e.g., compressed zip files) used for easily publishing and distributing schema sets and related artifacts, preferably include pure markup language schemas and may optionally include minimal markup language schemas. As with pure markup language schemas, the documentation is preferably stripped from minimal markup language schemas. Packages may include other related artifacts, such as documentation and data dictionaries.

### Schema Generator and Code Generator

Preferably, the schema generator 25 and/or the code generator 30 are operable to automatically generate XSLTs (Extensible Stylesheet Language Transformations) that will (a) transform pure xml to minimal xml for a given schema set and (b) transform minimal xml to pure xml for a given schema set.

Minimal markup language (e.g., XML) schemas are normalized markup language schemas within the schema framework 15. As a result, it is possible to generate code from a minimal markup language schema using the code generator 30. A problem that arises when generating code directly from a minimal markup language schema is that the resulting code generated API (the part of the code that human developers usually read) would typically use minimal element and attribute names, which are generally not appropriate for human use or consumption. In other words, a human developer may not be able to understand the code very well. Below features of the present invention are described for enhancing the code generation process in such a way as to merge the features and efficiencies of pure xml and minimal xml into a single code-generated library and sample source code.

Generated code from pure markup language schemas is operable to produce code that can consume and generate both pure instances and minimal instances interchangeably. At the same time, the code generated code preferably provides an API and sample source code using pure element and attribute names that are easy for human developers to use. Preferably, the internal, hidden code uses reduced code structures that match minimal xml names while providing an API that uses pure element and attribute names. The minimal markup language schemas do not need to be available to the code generator 30 to generate code. The code generator 30 preferably does not use the minimal markup language schemas to assist in code generation. Rather, the code generator 30 preferably uses the same rules used in the schema generation process 25 to generate the same minimal structures in code. In other words, from the human developer's perspective, the minimal code looks like “pure code” but it is natively “minimal code” but for the API (which is what the human developer would see and read).

Preferably, the user of code-generated code has the option to generate pure xml or minimal xml instances using the code library and the generated Pure API. Also preferably, a minimal API does not exist.

Additionally, the user of code-generated code preferably has the option to consume pure xml or minimal xml instances using the same code library and the same Pure API. Preferably, using the processing steps described above, the code-generated code can recognize a minimal xml instance from its namespace (and/or a pure xml instance) and then convert it to an internal format for processing.

Because applications that seek improved performance are likely to use minimal xml, preferably the internal code can process minimal xml natively, so that a transformation is not necessary when generating or consuming minimal xml, thus eliminating processing overhead (e.g., in a production application that is only running using minimal xml). Applications that use pure xml are likely to be less interested in performance. As a result, preferably the internal code can automatically transform from pure xml to minimal xml for internal processing resulting in acceptable additional processing overhead.

Preferably, internal, hidden code uses minimal structures. In contrast, external code preferably appear to human users in the same way that is typically appears to users for code generated from pure xml. For example, .dll names can be generated with the full name, such as xmlAddress001n20 (not xmla001n20). Directory structures preferably remain the same.

Preferably, sample source code remains human readable, except that an additional option is added for generating minimal xml.

### Document Repository

Preferably, instances are saved in the document repository 37 or other storage device or media using the same default file name format, except that minimal instances preferably include an additional “_XM” in the file name, between the pure name and the date. For example, pure and minimal instance based on a SmallClaims primary schema can be distinguished using the following filenames:

Pure: SmallClaims_{—}2007_{—}07_{—}05_{—}17_{—}11_{—}19_XML.xml

Minimal: SmallClaims_XM_{—}2007_{—}07_{—}05_{—}17_{—}11_{—}19_XML.xml

### Validation

Preferably, in generated code libraries, validation is done against the instance document that is to be generated or consumed. If the application is consuming XML, then validation preferably occurs prior to transforming the XML to an internal format. If the application is generating XML, then validation preferably occurs after the transformation from an internal format.

### Schema Repository

Documentation and data dictionaries for the schema repository 20 can be updated to accommodate links and mapping information to and from pure xml (existing) and minimal xml (new) documentation. Preferably, the schema repository 20 is able to store the Pure-to-Minimal and the Minimal-to-Pure XSLTs generated. Preferably, artifacts generated by the schema generator 25 can be uploaded into the schema repository.

### Code Repository

Preferably, pure xml and minimal xml features are included in the same code repository or library 40 (or are stored on another suitable storage device or media). Preferably, code can be uploaded, stored, and managed in a code repository 40.

Computer program products or elements of the present invention may be embodied in hardware and/or in software (including firmware, resident software, micro-code, etc.). A computer program product can be embodied on a computer-usable or computer-readable storage medium having computer-usable or computer-readable program instructions, “code” or a “computer program” embodied in the medium for use by or in connection with the instruction execution system. A computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. The computer-usable or computer-readable medium could even be paper or another suitable medium upon which the program is printed, as the program can be electronically captured, via, for instance, optical scanning of the paper or other medium, then compiled, interpreted, or otherwise processed in a suitable manner.

Although the present invention has described been described in terms of XML, those skilled in the art will understand that the present invention can be employed with other markup languages. Moreover, while the invention has been shown and described in preferred forms, it will be apparent to those skilled in the art that many modifications, additions, and deletions can be made therein. These and other changes can be made without departing from the spirit and scope of the invention as set forth in the following claims.

What is claimed is:

1. A system for generating a minimal markup language schema, comprising:
a schema generator configured to receive an original markup language schema as input and to process the original markup language schema in accordance with a predefined rule set to automatically generate a minimal markup language schema, wherein the minimal markup language schema has a structure identical to that of the original markup language schema but has at least one smaller element, attribute, complex type, simple type, and/or group name.

2. The system of claim 1, wherein the original markup language schema and the minimal markup language schema are stored in a schema repository communicatively coupled to the schema generator.

3. The system of claim 2, wherein once the original markup language schema is stored in the schema repository, the stored original markup language schema cannot be modified.

4. The system of claim 3, wherein the schema generator creates the minimal markup language schema from the pure markup language schema stored in the schema repository.

5. The system of claim 1, wherein the minimal markup language structure is mapped to its associated minimal markup language schema.

6. The system of claim 5, wherein the minimal markup language schema includes a mapping to the original markup language structure.

7. A system for generating a minimal markup language schema from a pure markup language schema, comprising:
a code generator operable to receive the pure markup language schema and to process the received pure markup language schema to generate one or more code libraries that generate and consume pure and minimal markup language instance documents that validate against the received original markup language schema and against the minimal markup language schema, respectively.

8. The system of claim 7, wherein at least one minimal markup language instance document includes an element manifest that appears on a root element of the minimal markup language schema.

9. A minimal markup language schema stored on a computer readable medium, the minimal markup language schema derived from an original markup language schema and having a markup language schema namespace associated therewith, the minimal markup language schema namespace including the original markup language schema namespace with a string of text appended thereto, wherein the minimal markup language schema has a structure identical to that of the original markup language schema.

10. The minimal markup language schema of claim 9, wherein the minimal markup language schema namespace includes an item name from the original markup language schema that is truncated.

11. The minimal markup language schema of claim 10, wherein the item name is truncated to a single character.

12. The minimal markup language schema of claim 11, wherein the minimal markup language schema namespace includes a manifest.

13. A method for generating a minimal markup language schema within a schema framework, comprising:
transforming an original markup language schema into a minimal markup language schema in accordance with a predefined rule set of the schema framework, wherein the minimal markup language schema has a structure identical to that of the original markup language schema but has at least one smaller element, attribute, complex type, simple type, and/or group name.

14. The method of claim 13, further comprising storing the original markup language schema and the minimal markup language schema on a computer readable medium.

15. The method of claim 14, further comprising freezing the original markup language schema once it is stored on the computer readable medium so that it cannot be modified.

16. The method of claim 15, wherein the step of transforming the original markup language schema into the minimal markup language schema further comprises transforming the original markup language schema stored on the computer readable medium into the minimal markup language schema.

17. A method of generating code within a markup language schema framework, comprising:
receiving as input a pure markup language schema, wherein the pure markup language schema has a minimal markup language schema associated therewith, the minimal markup language schema having a structure identical to that of the original markup language schema but has at least one smaller element, attribute, complex type, simple type, and/or group name;
generating minimal markup language code from the pure markup language schema, wherein the minimal markup language code includes code structures that match the minimal markup language schema; and
providing an application programming interface (API), wherein the API includes code structures that match the pure markup language schema.

18. The method of claim 17, wherein the code structures of the API include element and attribute names of the pure markup language schema.

19. The method of claim 17, wherein the code includes Extensible Stylesheet Language Transformations (XLST) that automatically translates pure markup language code to minimal markup language code and vice versa.
